(19) United States
(12) Patent Application Publication
(10) Pub. No.: US 2012/0086136 A1
(43) Pub. Date: Apr. 12, 2012

(54) AERATION APPARATUS AND SEAWATER FLUE GAS DESULPHURIZATION APPARATUS INCLUDING THE SAME

(75) Inventors: Keisuke Sonoda, Tokyo (JP); Shozo Nagao, Tokyo (JP)

(73) Assignee: MITSUBISHI HEAVY INDUSTRIES, LTD., Tokyo (JP)

(21) Appl. No.: 13/015,196

(22) Filed: Jan. 27, 2011

Related U.S. Application Data
(60) Provisional application No. 61/405,754, filed on Oct. 22, 2010.

(30) Foreign Application Priority Data
Oct. 8, 2010 (JP) 2010-229120

(51) Int. Cl. B01F 3/04; C02F 5/00; C02F 1/00; C02F 9/00

(52) U.S. Cl. 261/122.1; 210/696; 210/150; 210/151

(57) ABSTRACT

An aeration apparatus is immersed in diluted used seawater which is water to be treated and generates fine air bubbles in the diluted used seawater. The aeration apparatus includes: an air supply line L₅ having branch pipes L_{5A} to L_{5H} for supplying air 122 through blowers 121A to 121D serving as discharge unit; aeration nozzles 123 including diffuser membranes 11 having slits, through which the air 122 is supplied to the aeration nozzles 123 via headers 15 of the branch pipes L_{5A} to L_{5H}; a water tank 140 and a supply pump P₁ that are used as water introducing unit for supplying water 141 to the air supply line L₅. When pressure loss of the aeration nozzles 123 increases, the aeration apparatus stops introduction of the air 122 and supplies the water 141 into the branch pipes L_{5A} to L_{5H} branched from the air supply line L₅.

### FIELD

The present invention relates to wastewater treatment in a flue gas desulphurization apparatus used in a power plant such as a coal, crude oil, or heavy oil combustion power plant. In particular, the invention relates to an aeration apparatus for aeration used for decarboxylation (air-exposure) of wastewater (used seawater) from a flue gas desulphurization apparatus for desulphurization using a seawater method. The invention also relates to a seawater flue gas desulphurization apparatus including the aeration apparatus and to a method for removing and preventing precipitates in a slit of the aeration apparatus.

### BACKGROUND

In conventional power plants that use coal, crude oil, and the like as fuel, combustion flue gas (hereinafter referred to as “flue gas”) discharged from a boiler is emitted to the air after sulfur oxides (SOₓ) such as sulfur dioxide (SO₂) contained in the flue gas are removed. Known examples of the desulphurization method used in a flue gas desulphurization apparatus for the above desulphurization treatment include a limestone-gypsum method, spray dryer method, and seawater method.

In a flue gas desulphurization apparatus that uses the seawater method (hereinafter referred to as a “seawater flue gas desulphurization apparatus”), its desulphurization method uses seawater as an absorbent. In this method, seawater and flue gas from a boiler are supplied to the inside of a desulfurizer (absorber) having a vertical tubular shape such as a vertical substantially cylindrical shape, and the flue gas is brought into gas-liquid contact with the seawater used as the absorbent in a wet process to remove sulfur oxides. The seawater (used seawater) used as the absorbent for desulphurization in the desulfurizer flows through, for example, a long water passage having an open upper section (Seawater Oxidation Treatment System: SOTS) and is then discharged. In the long water passage, the seawater is decarbonated (exposed to air) by aeration that uses fine air bubbles ejected from an aeration apparatus disposed on the bottom surface of the water passage (Patent documents 1 to 3).

### CITATION LIST

### Patent Literature

Patent Literature 1: Japanese Patent Application Laid-open No. 2006-055779
Patent Literature 2: Japanese Patent Application Laid-open No. 2009-028570
Patent Literature 3: Japanese Patent Application Laid-open No. 2009-028572

### SUMMARY

### Technical Problem

Aeration nozzles used in the aeration apparatus each have a large number of small slits formed in a rubber-made diffuser membrane that covers a base. Such aeration nozzles are generally referred to as “diffuser nozzles.” These aeration nozzles can eject many fine air bubbles of substantially equal size from the slits with the aid of the pressure of the air supplied to the nozzles.

When aeration is continuously performed in seawater using the above aeration nozzles, precipitates such as calcium sulfate in the seawater are deposited on the wall surfaces of the slits of the diffuser membranes and around the openings of the slits, causing the gaps of the slits to be narrowed and the slits to be clogged. This results an increase in pressure loss of the diffuser membranes, and the discharge pressure of discharge unit, such as a blower or compressor, for supplying the air to the diffuser is thereby increased, so that disadvantageously the load on the blower or compressor increases.

The occurrence of the precipitates may be due to the following reason. Seawater present outside a diffuser membrane permeates inside the diffuser membrane through its slits and comes into continuous contact with air passing through the slits for a long time. Drying (concentration of the seawater) is thereby facilitated, and the precipitates are deposited.

In view of the above problem, it is an object of the present invention to provide an aeration apparatus that can control precipitates generated in the slits of diffuser membranes, a seawater flue gas desulphurization apparatus including the aeration apparatus, and a method for removing and preventing the precipitates in the slits of the aeration apparatus.

### Solution to Problem

According to an aspect of the present invention, an aeration apparatus that is immersed in water to be treated and generates fine air bubbles in the water to be treated includes: an air supply pipe for supplying air through discharge unit; an aeration nozzle including a diffuser membrane having a slit, the air being supplied to the aeration nozzle; and water introducing unit for introducing water into the air supply pipe. When pressure loss of the aeration nozzle increases, introduction of the air is stopped and water is introduced into the air supply pipe.

Advantageously, the aeration apparatus further includes water mist supplying unit for supplying water mist.

Advantageously, in the aeration apparatus, the water is one of fresh water and seawater.

Advantageously, the aeration apparatus further includes: a plurality of aeration nozzles provided on a plurality of headers branched from the air supply pipe; and an air discharge pipe arranged on an end portion of a branch pipe and each header for discharging air to the outside.

Advantageously, in the aeration apparatus, each of the aeration nozzles further includes the diffuser membrane covering a support body into which the air is introduced, and a large number of the slits formed therein, the fine air bubbles being ejected from the large number of slits.

According to another aspect of the present invention, a seawater flue gas desulphurization apparatus includes: a desulfurizer that uses seawater as an absorbent; a water passage for allowing used seawater discharged from the desulfurizer to flow therethrough and be discharged; and the aeration apparatus described above that is disposed in the water passage and generate fine air bubbles in the used seawater to decarbonate the used seawater.

According to still another aspect of the present invention, a method for removing and preventing a precipitate in a slit in an aeration apparatus includes: using an aeration apparatus that is immersed in water to be treated and used to generate fine air bubbles in the water to be treated from a slit of a diffuser membrane of an aeration nozzle; stopping introduction of air and introducing water into an air supply pipe when pressure loss of the aeration nozzle increases; and supplying the introduced water to the slit of the diffuser membrane for dissolving and removing a precipitate.

Advantageously, the method further includes: stopping introduction of the water; and introducing air in the air supply pipe to push out the water filled in the air supply pipe, thereby dissolving and removing the precipitate.

Advantageously, the method further includes: adding moisture or water vapor to the air to be supplied by discharge unit; and supplying air containing moisture to the slit of the diffuser membrane.

### Advantageous Effects of Invention

According to the present invention, even when precipitates are generated in the slits of the diffuser membranes of the aeration apparatus, the precipitates are quickly dissolved and removed. Therefore, it is possible to reduce the load on discharge unit, such as a blower or compressor, for supplying the air to the aeration apparatus.

### BRIEF DESCRIPTION OF DRAWINGS

FIG. 1 is a schematic diagram of a seawater flue gas desulphurization apparatus according to an embodiment.

FIG. 2A is a plan view of aeration nozzles.

FIG. 2B is a front view of the aeration nozzles.

FIG. 3 is a schematic diagram of the inner structure of an aeration nozzle.

FIG. 4 is a schematic diagram of an aeration apparatus according to an embodiment.

FIG. 5 is a schematic diagram of another aeration apparatus according to the embodiment.

FIG. 6A is a diagram illustrating the states of the outflow of air, the inflow of seawater, and concentrated seawater in a slit of a diffuser membrane.

FIG. 6B is a diagram illustrating the states of the outflow of air, the inflow of seawater, concentrated seawater, and a precipitate in the slit of the diffuser membrane.

FIG. 7 is a flowchart of an operation.

FIG. 8 is a schematic diagram of main parts of another aeration apparatus.

FIG. 9 is a schematic diagram of main parts of another aeration apparatus.

FIG. 10 is a schematic diagram of another aeration apparatus according to the embodiment.

FIG. 11 is a schematic diagram of another aeration apparatus according to the embodiment.

FIG. 12 is a schematic diagram of another aeration apparatus according to the embodiment.

FIG. 13A is a diagram illustrating the states of the outflow of air (a mixture of moisture-saturated air and water mist) and the inflow of seawater in a slit of a diffuser membrane.

FIG. 13B is a diagram illustrating the states of the outflow of air (moisture-saturated air) and the inflow of seawater in the slit of the diffuser membrane.

FIG. 13C is a diagram illustrating the states of the outflow of air (humid air, relative humidity: 100% or less), the inflow of seawater, and concentrated seawater in the slit of the diffuser membrane.

FIG. 14 is a set of graphs showing a change in the salt concentration in seawater entering the slits of aeration nozzles and the operating condition of an aeration apparatus when moisture is intermittently supplied to an air supply pipe.

### DESCRIPTION OF EMBODIMENTS

Hereinafter, the present invention will be described in detail with reference to the drawings. However, the present invention is not limited to embodiments described below. The components in the following embodiments include those readily apparent to persons skilled in the art and those substantially similar thereto.

### EMBODIMENTS

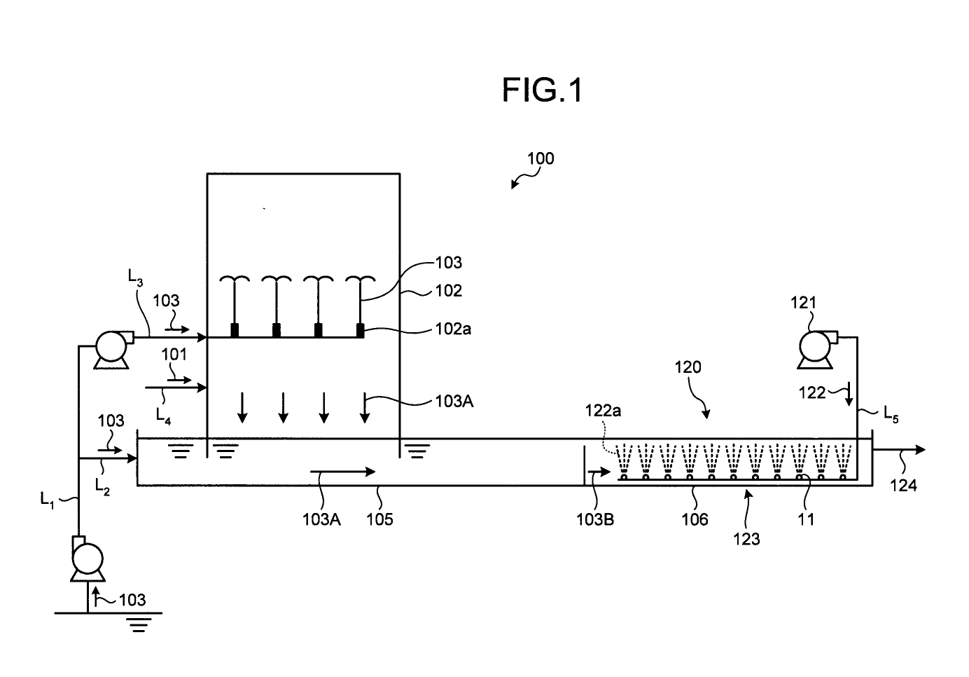

An aeration apparatus and a seawater flue gas desulphurization apparatus according to embodiments of the present invention will be described with reference to the drawings. FIG. 1 is a schematic diagram of the seawater flue gas desulphurization apparatus according to one embodiment.

As shown in FIG. 1, a seawater flue gas desulphurization apparatus 100 includes: a flue gas desulphurization absorber 102 in which flue gas 101 and seawater 103 comes in gas-liquid contact to desulphurize SO₂ into sulfurous acid (H₂SO₃); a dilution-mixing basin 105 disposed below the flue gas desulphurization absorber 102 to dilute and mix used seawater 103A containing sulfur compounds with dilution seawater 103; and an oxidation basin 106 disposed on the downstream side of the dilution-mixing basin 105 to subject diluted used seawater 103B to water quality recovery treatment.

In the seawater flue gas desulphurization apparatus 100, the seawater 103 is supplied through a seawater supply line L₁, and part of the seawater 103 is used for absorption, i.e., is brought into gas-liquid contact with the flue gas 101 in the flue gas desulphurization absorber 102 to absorb SO₂ contained in the flue gas 101 into the seawater 103. The used seawater 103A that has absorbed the sulfur components in the flue gas desulphurization absorber 102 is mixed with the dilution seawater 103 supplied to the dilution-mixing basin 105 disposed below the flue gas desulphurization absorber 102. The diluted used seawater 103B diluted and mixed with the dilution seawater 103 is supplied to the oxidation basin 106 disposed on the downstream side of the dilution-mixing basin 105. Air 122 supplied from an oxidation air blower 121 is supplied to the oxidation basin 106 from aeration nozzles 123 to recover the quality of the seawater, and the resultant water is discharged to the sea as treated water 124.

In FIG. 1, reference numeral 102a represents spray nozzles for injecting seawater 103 upward as liquid columns; 120 represents an aeration apparatus; 122a represents air bubbles; L₁ represents a seawater supply line; L₂ represents a dilution seawater supply line; L₃ represents a desulphurization seawater supply line; L₄ represents a flue gas supply line; and L₅ represents an air supply line.

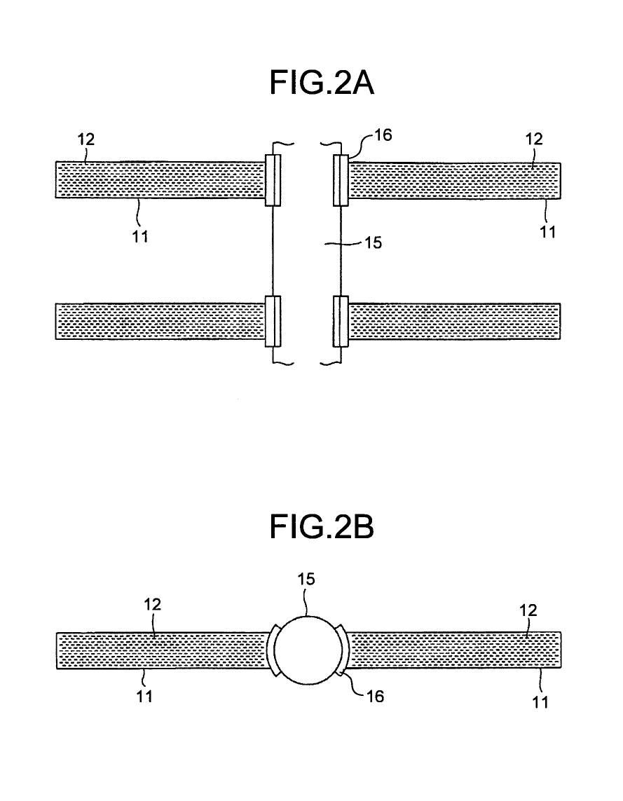

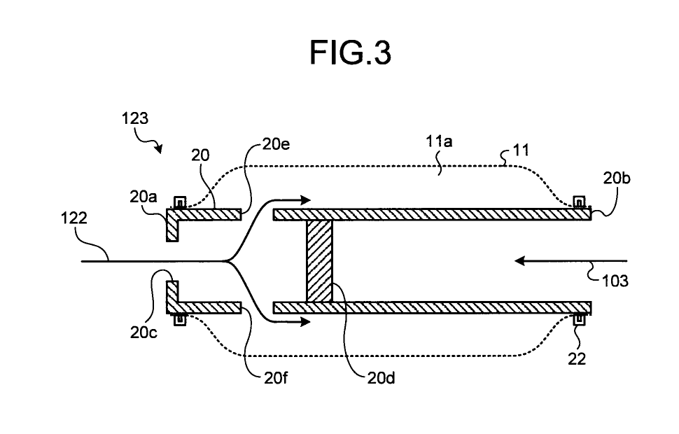

The structure of the aeration nozzles 123 is described with reference to FIGS. 2A, 2B, and 3 when a diffuser membrane is made of rubber.

FIG. 2A is a plan view of the aeration nozzles; FIG. 2B is a front view of the aeration nozzles; and FIG. 3 is a schematic diagram of the inner structure of an aeration nozzle.

As shown in FIGS. 2A and 2B, each aeration nozzle 123 has a large number of small slits 12 formed in a rubber-made diffuser membrane 11 that covers the circumference of a base and is generally referred to as a “diffuser nozzle.”In such an aeration nozzle 123, when the diffuser membrane 11 is expanded by the pressure of the air 122 supplied from the air supply line L₅, the slits 12 open to allow a large number of fine air bubbles of substantially equal size to be ejected.

As shown in FIGS. 2A and 2B, the aeration nozzles 123 are attached through flanges 16 to headers 15 provided in a plurality of (eight in the present embodiment) branch pipes (not shown) branched from the air supply line L₅. In consideration of corrosion resistance, resin-made pipes, for example, are used as the branch pipes and the headers 15 disposed in the diluted used seawater 103B.

For example, as shown in FIG. 3, each aeration nozzle 123 is formed as follows. A substantially cylindrical support body 20 that is made of a resin in consideration of corrosion resistance to the used seawater 103B is used, and a rubber-made diffuser membrane 11 having a large number of slits 12 formed therein is fitted on the support body 20 so as to cover its outer circumference. Then the left and right ends of the diffuser membrane 11 are fastened with fastening members 22 such as wires or bands.

The slits 12 described above are closed in a normal state in which no pressure is applied thereto. In the seawater flue gas desulphurization apparatus 100, when the air 122 is continuously supplied, the slits 12 are constantly in an open state.

A first end 20a of the support body 20 is attached to a header 15 and allows the introduction of the air 122, and the support body 20 has an opening at its second end 20b that allows the introduction of the seawater 103.

In the support body 20, the side close to the first end 20a is in communication with the inside of the header 15 through an air inlet port 20c that passes through the header 15 and the flange 16. The inside of the support body 20 is partitioned by a partition plate 20d disposed at some axial position in the support body 20, and the flow of air is blocked by the partition plate 20d. Air outlet holes 20e and 20f are formed in the side surface of the support body 20 and disposed on the header 15 side of the partition plate 20d. The air outlet holes 20e and 20f allow the air 122 to flow between the inner circumferential surface of the diffuser membrane 11 and the outer circumferential surface of the support body, i.e., into a pressurization space 11a for pressurizing and expanding the diffuser membrane 11. Therefore, the air 122 flowing from the header 15 into the aeration nozzle 123 flows through the air inlet port 20c into the support body 20 and then flows through the air outlet holes 20e and 20f formed in the side surface into the pressurization space 11a, as shown by arrows in FIG. 3.

The fastening members 22 fasten the diffuser membrane 11 to the support body 20 and prevent the air flowing through the air outlet holes 20e and 20f from leaking from the opposite ends.

In the aeration nozzle 123 configured as above, the air 122 flowing from the header 15 through the air inlet port 20c flows through the air outlet holes 20e and 20f into the pressurization space 11a. Since the slits 12 are closed in the initial state, the air 122 is accumulated in the pressurization space 11a to increase the inner pressure. The increase in the inner pressure of the pressurization space 11a causes the diffuser membrane 11 to expand, and the slits 12 formed in the diffuser membrane 11 are thereby opened, so that fine bubbles of the air 122 are injected into the diluted used seawater 103B. Such fine air bubbles are generated in all the aeration nozzles 123 to which air is supplied through branch pipes L_{5A} to L_{5H} (which will be described below) and the headers 15.

Aeration apparatuses according to an embodiment will next be described. The present invention provides means for dissolving and removing precipitates such as calcium sulfate generated by drying and concentration of seawater in the slits 12 of the diffuser membranes 11 when the precipitates results an increase in pressure loss of the aeration nozzles 123.

The present invention will next be described specifically.

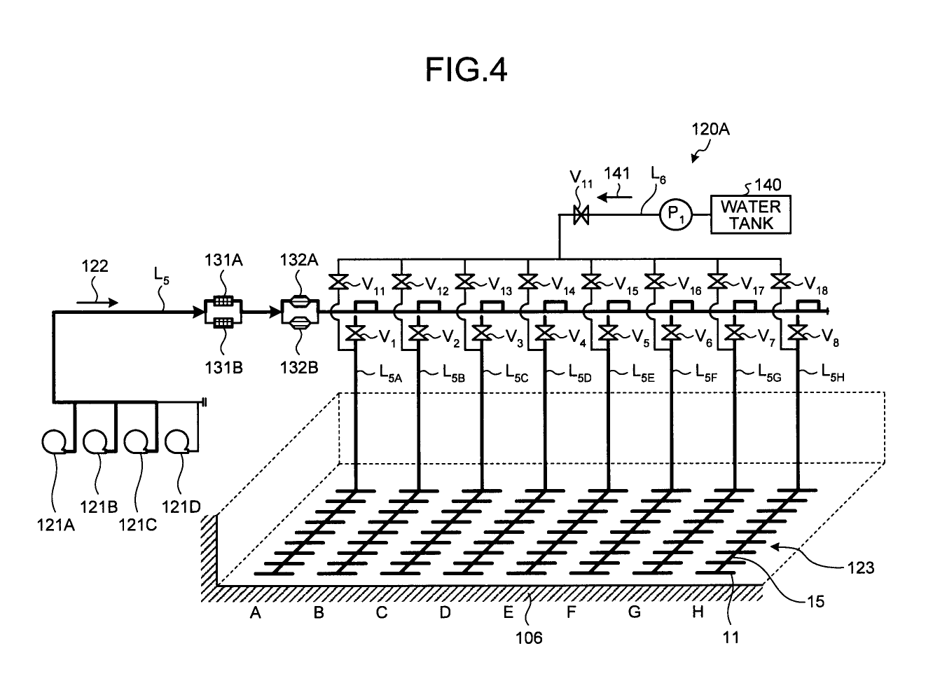

FIG. 4 is a schematic diagram of the aeration apparatus according to the present embodiment.

As shown in FIG. 4, an aeration apparatus 120A according to the present embodiment is immersed in diluted used seawater (not shown), which is water to be treated, and generates fine air bubbles in the diluted used seawater. This aeration apparatus includes: an air supply line L₅ having the branch air supply lines (branch pipes) L_{5A} to L_{5H} serving as air supply lines for supplying air 122 from blowers 121A to 121D serving as discharge unit; aeration nozzles 123 each including a diffuser membrane 11 having slits 12 for supplying the air 122 through respective headers 15 of the branch pipes L_{5A} to L_{5H}; and a water tank 140 and a supply pump P₁, which are water introducing unit for supplying water 141 to the air supply line L₅. When pressure loss of the aeration nozzles 123 increases, the aeration apparatus 120A stops introduction of the air 122 and introduces the water 141 into the branch pipes L_{5A} to L_{5H} that are branched from the air supply line L₅. The water 141 is introduced from a water supply line L₆ and valves V₁₁ to V₁₈ are interposed in respective branch lines.

Two cooling units 131A and 131B and two filters 132A and 132B are provided in the air supply line L₅. The air compressed by the blowers 121A to 121D is thereby cooled and then filtrated.

Normally, three of the four blowers are used for operation, and one of them is a reserve blower. Since the aeration apparatus must be continuously operated, only one of the two cooling units 131A and 131B and only one of the two filters 132A and 132B are normally used, and the others are used for maintenance.

In the present embodiment, fresh water is used to supply the water 141. However, instead of the fresh water, seawater (such as seawater 103 from the dilution seawater supply line L₂, used seawater 103A in the dilution-mixing basin 105, or diluted used seawater 103B in the oxidation basin 106) may be used.

In the present embodiment, when pressure loss of the aeration nozzles 123 increases, the introduction of the air 122 is stopped and the water (fresh water or seawater) 141 is supplied from the water tank 140. Therefore, the water introduced from the headers 15 dissolves adhered calcium sulfate and the like while passing through the slits 12 of the diffuser membranes 11 of the aeration nozzles 123. Accordingly, the pressure loss of the diffuser membranes 11 can be reduced.

The amount of water to be introduced may be adjusted through flow rate management to obtain a predetermined flow rate by operating valves.

### [Measures Against Generation of Adhered Matters]

At the initial stage of the operation of the aeration apparatus, a control unit introduces the air 122 into the air supply line L₅ and performs only normal aeration. In this case, the water 141 is not introduced into the air supply line L₅.

When adhered matters are generated in the slits 12, the pressure loss of the aeration nozzles 123 increases to a defined value or more. When such an increase in the pressure loss occurs, the introduction of the air 122 is first stopped. The water 141 is next introduced into the branch air supply lines L_{5A} to L_{5H}, which are branched from the air supply line L₅, from the water tank 140, so that each aeration nozzle 123 is filled with the introduced water 141. The water 141 dissolves adhered calcium sulfate and the like when passing through the slits 12 of the diffuser membranes 11 of the aeration nozzles 123, so that the pressure loss of the diffuser membranes 11 can be reduced.

The switching operation will next be described. When the pressure loss increases to a predetermined value, the supply of the air 122 is stopped (OFF) and water is introduced (ON). The water 141 is continuously introduced for a predetermined time. Then the introduction of the water 141 is stopped (OFF) and air is supplied (ON) to introduce rated air, so that the aeration is resumed. For resuming the aeration, the air 122 is gradually introduced so that water remaining inside can be discharged.

In this case, once the water is introduced and the aeration nozzles 123 are filled with the water 141, it may be possible to stop the introduction of the water and gradually introduce air so that the filled water can be pushed out with the aid of the introduced air.

This configuration is preferable when the available flow rate of water is low.

The salt concentration in seawater is generally about 3.4%, and 3.4% of salts are dissolved in 96.6% of water. The salts include 77.9% of sodium chloride, 9.6% of magnesium chloride, 6.1% of magnesium sulfate, 4.0% of calcium sulfate, 2.1% of potassium chloride, and 0.2% of other salts.

Of these salts, calcium sulfate is deposited first as seawater is concentrated (dried), and the deposition threshold value of the salt concentration in seawater is about 14%.

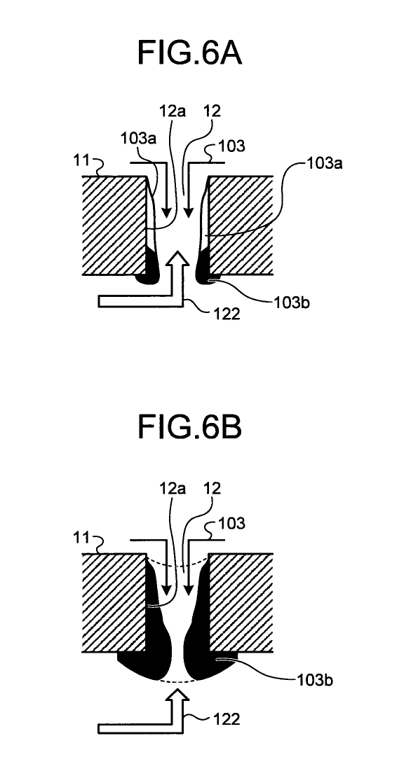

FIG. 6A is a diagram illustrating the states of the outflow of air, the inflow of seawater, and concentrated seawater in a slit of a diffuser membrane. FIG. 6B is a diagram illustrating the states of the outflow of air, the inflow of seawater, concentrated seawater, and a precipitate in the slit of the diffuser membrane.

In the present invention, the slits 12 are cuts formed in the diffuser membranes 11, and the gap of each slit 12 serves as a discharge passage of air.

The seawater 103 is in contact with slit wall surfaces 12a that form the passage. The introduction of the air 122 causes the seawater 103 to be dried and concentrated to form concentrated seawater 103a. Then a precipitate 103b is deposited on the slit wall surfaces 12a and clogs the passage in the slits 12.

FIGS. 6A and 6B show the growth states of the precipitate in the slit 12 of the diffuser membrane 11 as the drying and concentration of the seawater due to the air 122 proceed.

In the state shown in FIG. 6A, the precipitate 103b is generated in portions of the concentrated seawater 103a in which the salt concentration in the seawater locally exceeds 14%. In this state, the amount of the precipitate 103b is very small. Therefore, although the pressure loss when the air 122 passes through the slit 12 increases slightly, the air 122 can pass through the slit 12.

However, in the state shown in FIG. 6B, since the concentration of the concentrated seawater 103a has proceeded further, a clogged (plugged) state due to the precipitate 103b is formed, and the pressure loss is high. Even in this state, the passage of the air 122 remains present, but the load on the discharge unit is considerably large. Therefore, the pressure loss of the aeration nozzle 123 increases.

The switching operation may be performed manually or automatically.

For the automatic operation, the control unit is made up of a microcomputer or the like. The control unit is provided with a storage unit (not shown) made up of a RAM or ROM for storing programs and data. When an increase in the pressure loss of the aeration nozzle 123 to a predetermined value or more is confirmed, the data stored in the storage unit is used for detecting generation of a large amount of adhered matters in the slit 12 and confirming a block in which the pressure loss of the aeration nozzle 123 occurs from among blocks (eight blocks in the present embodiment (first to eighth blocks A to H shown in FIG. 4)).

The control unit is connected to the valves V₁ to V₈ of the branch pipes L_{5A} to L_{5H} for supplying the water 141 from the water tank 140. When the pressure loss occurs, the control unit issues a command to stop the supply of the air 122 that is supplied to each of the blocks A to H (eight blocks).

For example, assuming that the pressure loss has occurred in the aeration nozzle 123 in the first block A, the control unit issues a command to close the valve V₁ interposed in the branch pipe L_{5A} in the first block A. Therefore, the supply of the air 122 to this block is stopped.

The control unit then issues a command to open the valve V₁₁ to supply and introduce the water 141 into the branch pipe L_{5A} from the water tank 140.

The water 141 introduced into the branch pipe L_{5A} is further introduced into the aeration nozzle 123 through the header 15 and then discharged to the outside from the slit 12 provided in the diffuser membrane 11.

When the water 141 is discharged, the water dissolves the precipitate such as calcium sulfate deposited on the slit 12 and allows the precipitate in the slit to be discharged to the outside.

The control unit introduces the water 141 for a predetermined time, and thereafter, issues a command to stop the introduction of the water 141 (to close the valve V₁₁) and a command to open the valve V₁ to resume the supply of the air 122 to this block. Accordingly, the aeration is resumed. The time for introducing the water is appropriately set depending on the state of the pressure loss or the deposition state of the precipitate.

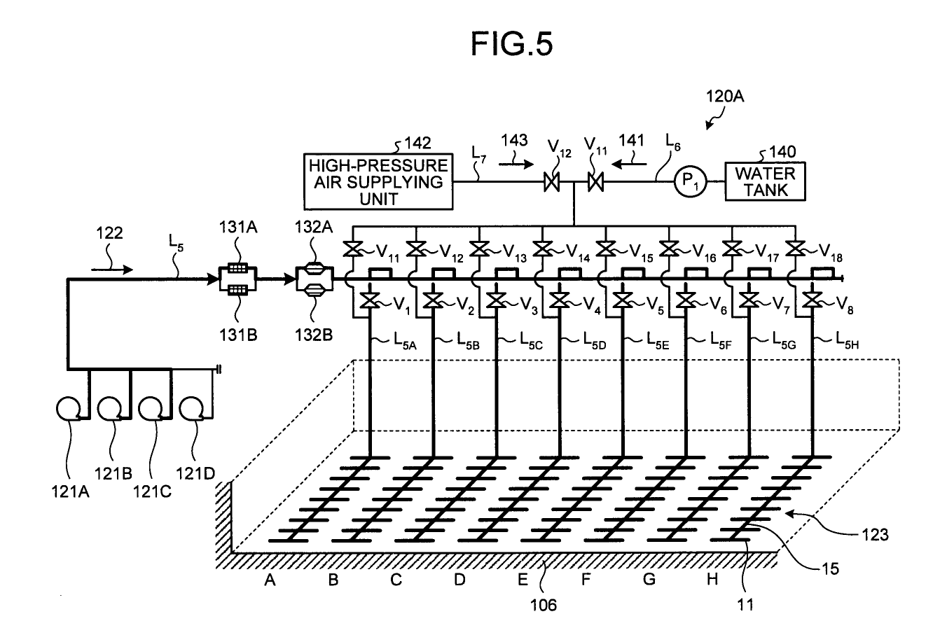

FIG. 5 is a schematic diagram of another aeration apparatus according to the present embodiment.

As shown in FIG. 5, the present embodiment provides means for supplying high-pressure air 143 from a high-pressure air supplying unit 142 through a high-pressure air supply line L₇.

Therefore, when the aeration is resumed, the water remaining in the branch pipe L_{5A} and the aeration nozzle 123 can quickly be flushed out. Reference symbol V₁₂ denotes a switching valve for introducing high-pressure air.

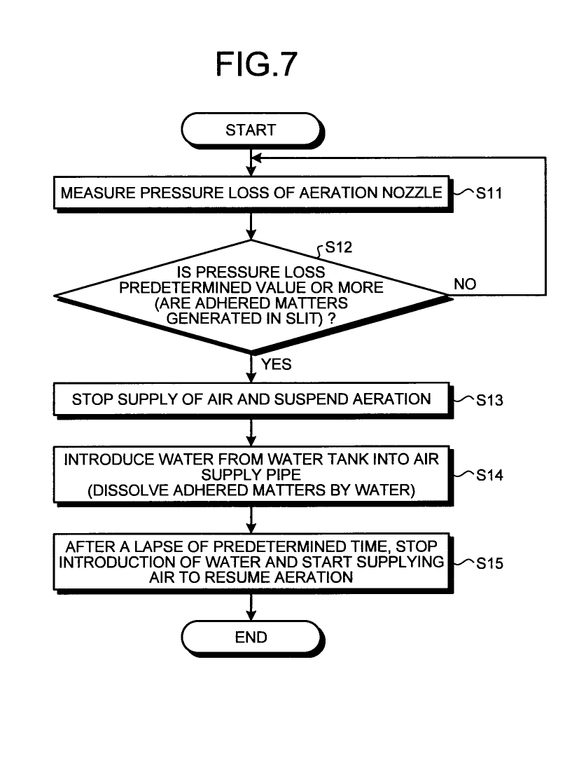

Control by the control unit to cope with the increase in the pressure loss of the aeration nozzle 123 will next be described. FIG. 7 is a flowchart of an operation.

The control unit measures pressure (internal pressure and water pressure) using a manometer (not shown) and measures pressure loss of the aeration nozzle 123 (Step S11).

When the measured pressure loss is a predetermined value or more (adhered matters are generated in the slit 12) (Step S12: YES), the control unit confirms a block in which the pressure loss occurs and stops the supply of the air 122 to this block (Step S13).

The water 141 is introduced from the water tank 140 into the branch pipe for which the supply of the air 122 is stopped, so that the water 141 is supplied to the aeration nozzle 123 (the adhered matters are dissolved in the introduced water) (Step S14).

The water 141 is caused to flow for a predetermined time. Then the introduction of the water 141 is stopped and the air 122 is supplied to resume the aeration (Step S15).

When the measured pressure loss is the predetermined value or less (Step S12: NO), measurement of the pressure loss is continued (Step S11).

In the present embodiment, when the pressure loss of the aeration nozzle 123 increases to a predetermined value or more, the introduction of the air 122 is stopped and the water (fresh water or seawater) 141 is supplied. Therefore, the precipitate deposited on the slit 12 of the aeration nozzle 123 can be dissolved, enabling to reduce the pressure loss.

When a plurality of blocks (such as eight blocks A to H) is provided, even when the supply of the air 122 to one block is stopped, because the air 122 for this block is additionally distributed to the rest of the blocks, the amount of the air 122 needed for SOTS can be ensured.

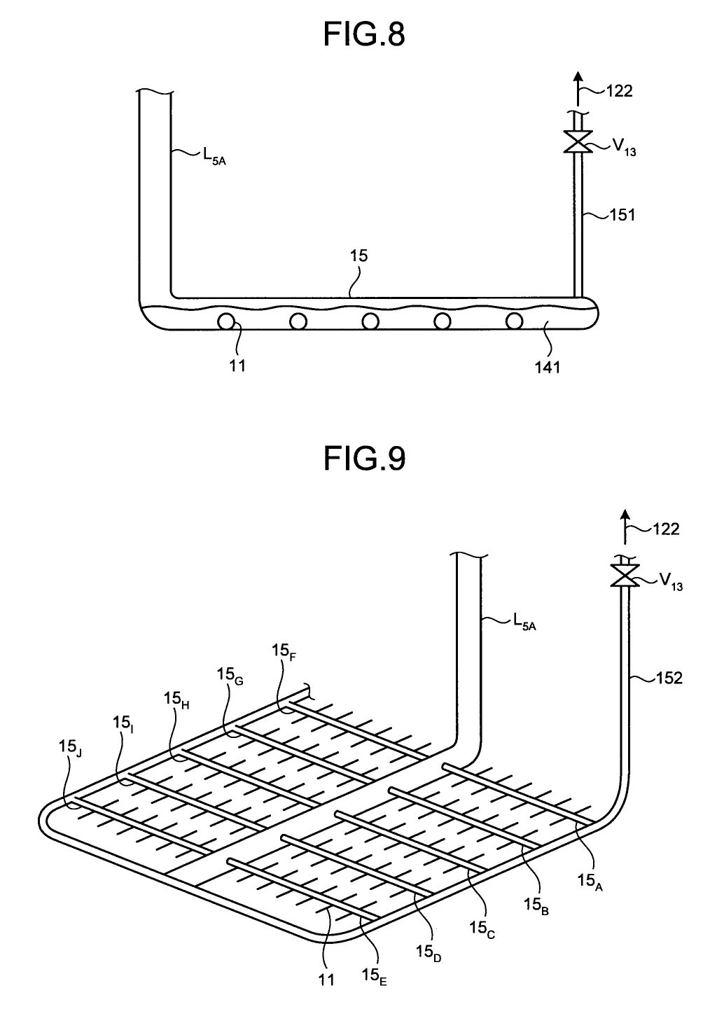

FIG. 8 is a schematic diagram of main parts of another aeration apparatus. As shown in FIG. 8, the air 122 remains in an edge portion of the header 15 of the air supply line L_{5A} even after the introduction of the air 122 is stopped. Therefore, an air discharge pipe 151 is provided for discharging the air 122 from the inside to the outside so that the water 141 can be filled in the whole area.

With the air discharge pipe 151, the air 122 remaining in the pipe can be quickly discharged to the outside when the water 141 is introduced into the inside. Therefore, the water 141 can be introduced into the aeration nozzles 123 in the all of the headers 15. After the discharge of the air 122 is complete, the valve V₁₃ is closed to prevent the introduced water 141 from being discharged.

FIG. 9 is a schematic diagram of main parts of another aeration apparatus. As shown in FIG. 9, when a plurality of headers 15_{A} to 15_{J} are additionally provided from the air supply line L_{5A}, a communication air discharge pipe 152 is provided for allowing end portions of the headers 15_{A} to 15_{J} to communicate with each other.

With the communication air discharge pipe 152, the air 122 remaining inside of the headers 15_{A} to 15_{J} can be quickly discharged to the outside when the water 141 is introduced into the headers 15_{A} to 15_{J}.

In the present embodiment, plugging caused by deposition of seawater components and contamination components such as sludge on diffuser slits (membrane slits) can be quickly relieved in the aeration apparatuses for aeration of seawater. Therefore, the aeration apparatuses can be stably operated for a long time.

In the description in the present embodiment, seawater is exemplified as water to be treated, but the invention is not limited thereto. For example, in an aeration apparatus for aerating polluted water in polluted water treatment (such as sewage treatment), plugging caused by deposition of contamination components such as sludge on diffuser slits (membrane slits) can be prevented, and the aeration apparatus can be stably operated for a long time.

With the above measures, the plugging that occurs in the aeration apparatus can be quickly relieved.

Any preventive measures against the plugging may further be taken in addition to the above measures.

### [Preventive Measures Against Generation of Adhered Matters]

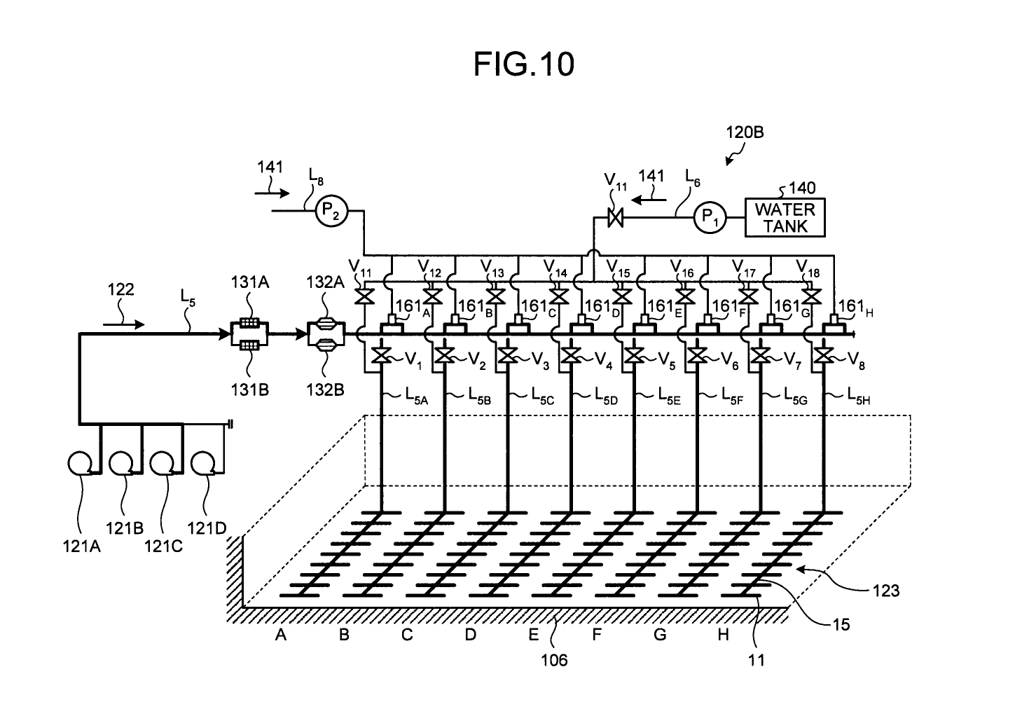

FIG. 10 is a schematic diagram of another aeration apparatus according to the present embodiment.

As shown in FIG. 10, an aeration apparatus 120B according to the present embodiment includes water mist supplying unit including nozzles 161_{A} to 161_{H} for supplying the water 141 to the branch pipes L_{5A} to L_{5H} that are branched from the air supply line L₅. Reference symbol P₂ denotes a water supply pump.

In the present embodiment, since the water mist supplying unit supplies mist of the water (fresh water or seawater) 141 from the nozzles 161_{A} to 161_{H} through the water supply line L₈, the air 122 supplied to the aeration nozzles 123 can be humidified (the partial pressure of water vapor in the air 122 can be increased).

In the aeration apparatus 120B shown in FIG. 10, single-fluid nozzles are used as the nozzles 161_{A} to 161_{H} for spraying the water into the supplied air 122.

In the aeration apparatus 120B shown in FIG. 10, two-fluid nozzles may be used by separately providing an air supply line (not shown) to supply the air 122 to the nozzles 161_{A} to 161_{H}. This air 122 is used as assist gas when the water (fresh water or seawater) 141 is supplied. More specifically, the moisture is finely sprayed with the assist gas into the air 122 supplied from the air supply line L₅ (in order to facilitate evaporation of the moisture).

In the air supply systems shown in FIG. 10 above, the cooling units 131A and 131B may be omitted. In this case, a predetermined amount of the water (fresh water or seawater) 141 is injected into the air 122 pressurized by the blowers 121A to 121D and increased in temperature to reduce the temperature of the air 122 to be supplied so that the air 122 in the slits 12 of the aeration nozzles 123 is saturated with moisture.

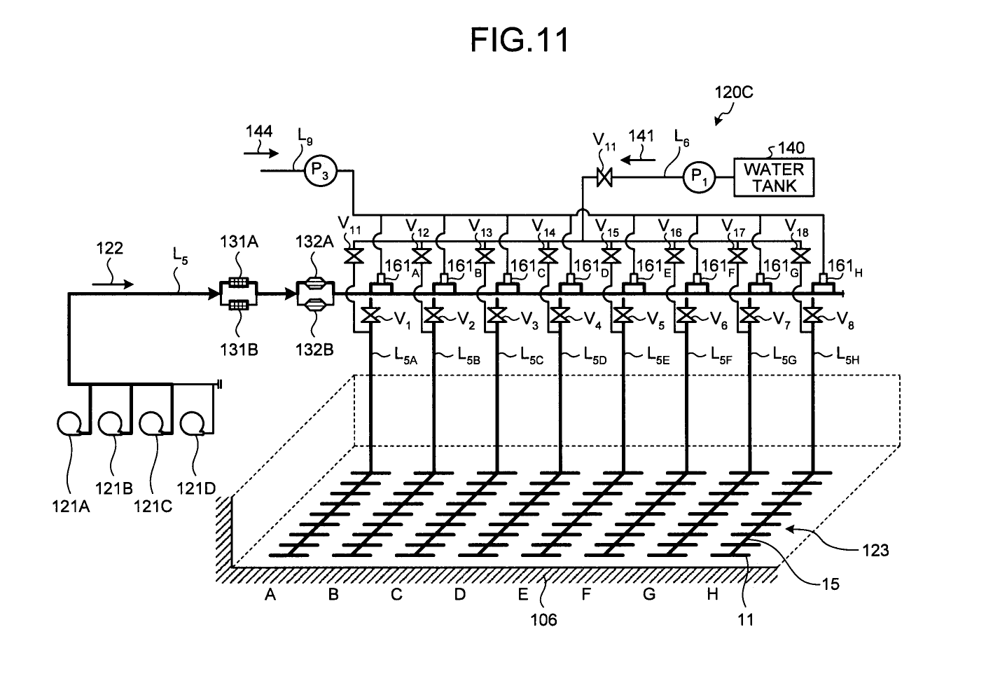

FIG. 11 is a schematic diagram of another aeration apparatus according to the present embodiment.

An aeration apparatus 120C shown in FIG. 11 supplies water vapor 144 through a water vapor supply line L₉. Reference symbol P₃ denotes a water vapor supply pump.

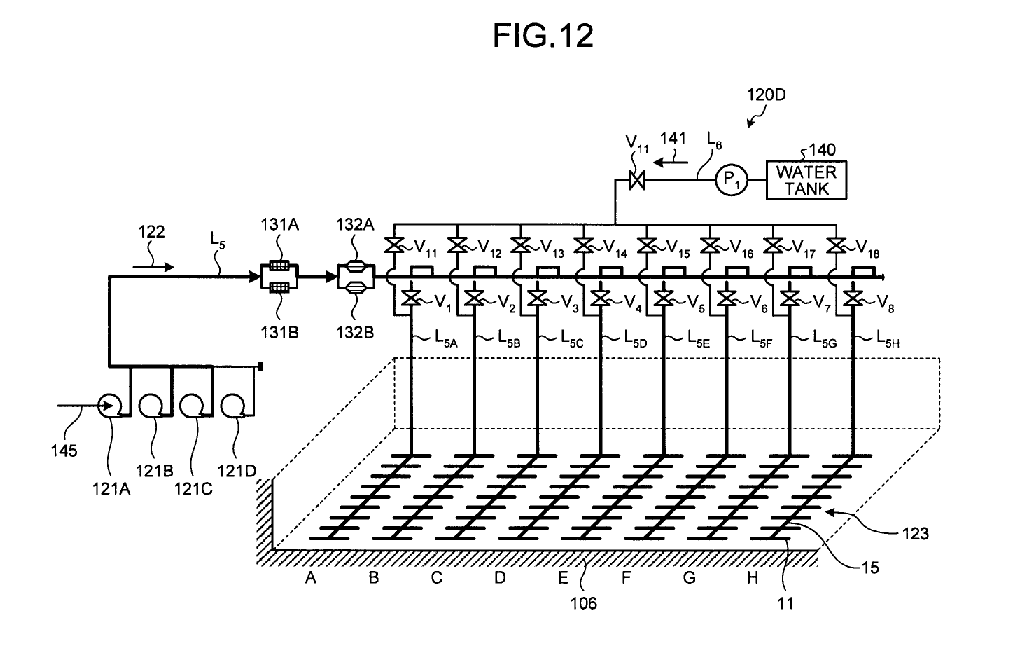

FIG. 12 is a schematic diagram of another aeration apparatus according to the present embodiment.

In an aeration apparatus 120D shown in FIG. 12, intake spray nozzles (not shown) for supplying moisture 145 are provided near the air inlets of the blowers 121A to 121D, which serve as discharge unit. In this case, the moisture 145 is added to intake air (the moisture is vaporized before it enters the blowers), and the amount of cooling in the cooling unit 131A on the outlet side of the blowers is controlled so that the air passing through the slits 12 of the aeration nozzles 123 is moisture-saturated air.

More specifically, the temperature of the air 122 pressurized and compressed by the blowers 121A to 121D is as high as, for example, about 100° C. However, when an excess amount of the moisture 145 is supplied before pressurization and compression, the air 122 to be supplied is moisture rich. Then the temperature of the air is reduced by the cooling unit 131A (to, for example, 40° C.) Since the amount of moisture in the air 122 is unchanged, the degree of moisture saturation (the relative humidity) of the cooled air 122 increases. Therefore, the relative humidity of the air in the slits 12 of the aeration nozzles 123 is 100%. When the amount of water added to the intake air is further increased, moisture-saturated air containing water mist is formed, and a gas-liquid two-phase state is formed.

Even when the relative humidity of the air sucked by the blowers 121A to 121D is 100% on the inlet side of the blowers 121A to 121D, the relative humidity of the air in the slits 12 of the aeration nozzles 123 may not be 100% because the air is compressed and cooled. In such a case, if the shortage of the moisture 145 is supplied on the inlet side of the blowers, unevaporated moisture enters the blowers, which is not preferred. In this case, moisture such as fresh water or seawater is supplied on the outlet side of the blowers 121A to 121D or the downstream side of the cooling units 131A and 131B.

When moisture is supplied to the air 122 in each of the cases shown in FIGS. 10 to 12 described above, the amount of moisture supplied and the amount of cooling in the cooling unit are adjusted according to the air conditions (pressure, temperature, and relative humidity) at the inlet side of the blowers and in consideration of pressure loss and heat exchange between the air supply pipe and the outside such that the air passing through the slits 12 of the aeration nozzles 123 is moisture-saturated air or moisture-saturated air entraining water mist.

As described above, moisture-saturated air or moisture-saturated air entraining water mist is supplied to the aeration nozzles 123. This prevents drying (concentration) of seawater that enters the slits 12 of the diffuser membranes 11 and thereby prevents the deposition of salts, such as calcium sulfate, in the seawater. When concentrated seawater is formed in the slits, the water mist contributes to relaxation of the concentration of the seawater (a reduction in salt concentration).

By supplying moisture (fresh water, water vapor, or seawater) as described above, the air 122 supplied to the aeration nozzles 123 is saturated with the water vapor 144. This prevents drying (concentration) of the seawater that enters the slits 12 of the diffuser membranes 11 and thereby prevents the deposition of calcium sulfate and the like. In this manner, the pressure loss of the diffuser membranes 11 can be prevented.

Preferably, the amount of moisture supplied is set such that the air passing through the slits 12 of the aeration nozzles 123 is air fully saturated with moisture. More preferably, the amount of moisture supplied is set such that the air is moisture-saturated air entraining water mist (in a gas-liquid two-phase state). The relative humidity of the air 122 flowing into the slits 12 of the aeration nozzles 123 is 40% or more, preferably 60% or more, and more preferably 80% or more. Conditions under which the concentrating rate of seawater in the slits 12 is slow may be used depending on the maintenance time of the apparatus.

The humidity condition of the air passing through the slits 12 of the aeration nozzles 123 is controlled by adjusting the humidity of air sucked by the blowers 121A to 121D, the amount of moisture supplied, the amount of cooling in the cooling unit, and the like.

In this manner, the seawater entering the slits 12 of the diffuser membrane 11 is prevented from being dried, and the degree of concentration of the seawater (an increase in salt concentration) is suppressed, so that the salt concentration in the seawater can be maintained at about 14% or less.

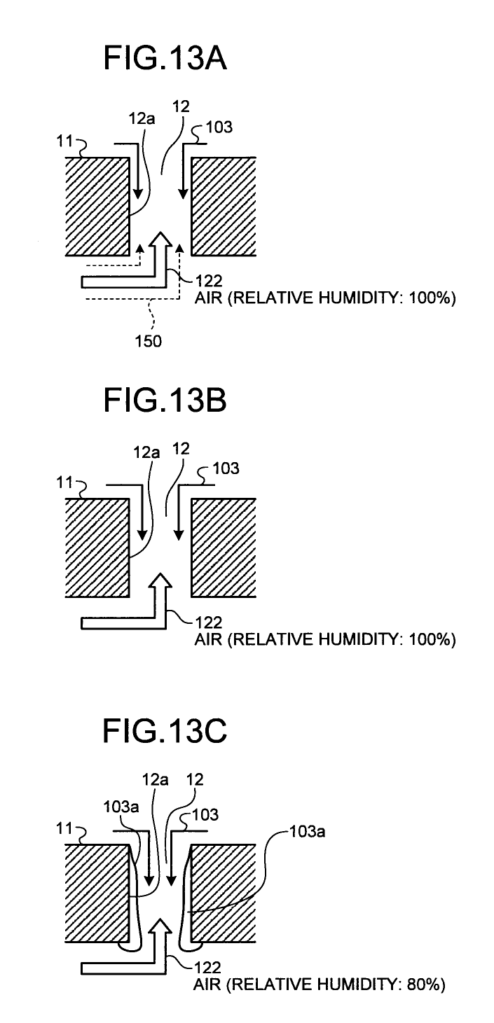

FIGS. 13A to 13C are diagrams illustrating the states of the outflow of air (to which moisture has been supplied) and the inflow of the seawater 103 in the slit 12 of the diffuser membrane 11.

In the state shown in FIG. 13A, the relative humidity of the air 122 is 100% (moisture-saturated air), and the air 122 entrains water mist 150 to form a gas-liquid two-phase state. Therefore, the seawater 103 entering the slit 12 is not dried (concentrated), and the salt concentration is reduced, so that the drying (concentration) of the seawater is prevented.

In the state shown in FIG. 13B, the relative humidity of the air 122 is 100%. Therefore, the salt concentration in seawater 103 is unchanged, and the drying of the seawater is prevented.

In the state shown in FIG. 13C, the relative humidity of the air 122 is, for example, 80%. Therefore, the drying of the seawater 103 is suppressed. The salt concentration in the seawater 103 increases gradually, and concentrated seawater 103a is formed. However, even if the concentration of the seawater is initiated, deposition of calcium sulfate and the like does not occur when the salt concentration in the seawater is about 14% or less. Therefore, in this state, by intermittently introducing moisture-saturated air entraining water mist 150 to force the formation of a moisture-rich state, the salt concentration increased to some extent is reduced, and the deposition is thereby avoided. In this manner, the apparatus can be operated for a long time.

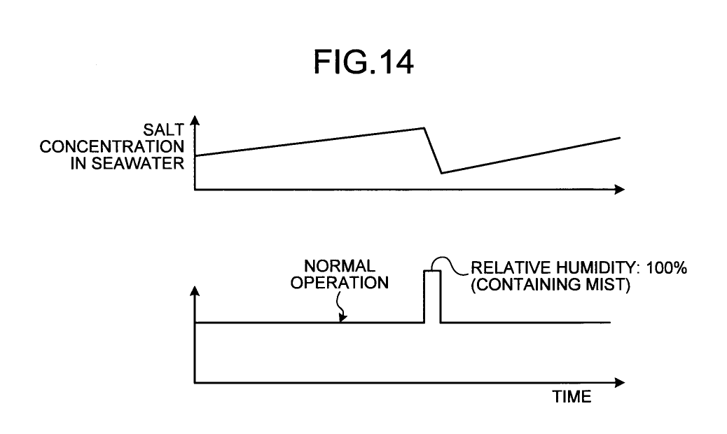

FIG. 14 is a set of graphs showing a change in the salt concentration in seawater entering the slits of aeration nozzles and the operating condition of an aeration apparatus when moisture is intermittently supplied to an air supply pipe. As shown in FIG. 14, when air with a relative humidity of 100% or less is supplied, moisture-rich moisture-saturated air having a humidity of 100% and containing water mist 150 or moisture-saturated air entraining water mist 150 is intermittently introduced after normal operation is performed for a predetermined time (the introduction period is illustrated as a peak). In this manner, the operation can be performed without deposition of calcium sulfate and the like.

In the present embodiment, plugging caused by deposition of seawater components and contamination components such as sludge on diffuser slits (membrane slits) can be prevented in the aeration apparatuses for aeration of seawater. Therefore, an increase in pressure loss in the aeration apparatuses can be prevented, and the aeration apparatuses can be stably operated for a long time.

In the description of the present embodiment, tube-type aeration nozzles are used in the aeration apparatuses, but the present invention is not limited thereto. For example, the invention is applicable to disk-type and flat-type aeration apparatuses having diffuser membranes and to diffusers including ceramic or metal diffuser membranes having slits that are open at all times.

### INDUSTRIAL APPLICABILITY

As described above, in the aeration apparatus according to the present invention, precipitates generated in the slits of the diffuser membranes of the aeration apparatus can be removed and the occurrence of precipitates can be suppressed. For example, when applied to a seawater flue gas desulphurization apparatus, the aeration apparatus can be continuously operated in a stable manner for a long time.

### REFERENCE SIGNS LIST

11 diffuser membrane
12 slit
100 seawater flue gas desulphurization apparatus
102 flue gas desulphurization absorber
103 seawater
103a concentrated seawater
103b precipitate
103A used seawater
103B diluted used seawater
105 dilution-mixing basin
106 oxidation basin
120A to 120D aeration apparatus
122 air
123 aeration nozzle
140 water tank
141 water

1. An aeration apparatus that is immersed in water to be treated and generates fine air bubbles in the water to be treated, the aeration apparatus comprising:
an air supply pipe for supplying air through discharge unit;
an aeration nozzle including a diffuser membrane having a slit, the air being supplied to the aeration nozzle; and
water introducing unit for introducing water into the air supply pipe, wherein
when pressure loss of the aeration nozzle increases, introduction of the air is stopped and water is introduced into the air supply pipe.

2. The aeration apparatus according to claim 1, further comprising:
water mist supplying unit for supplying water mist.

3. The aeration apparatus according to claim 1, wherein
the water is one of fresh water and seawater.

4. The aeration apparatus according to claim 1, further comprising:
a plurality of aeration nozzles provided on a plurality of headers branched from the air supply pipe; and
an air discharge pipe arranged on an end portion of a branch pipe and each header for discharging air to the outside.

5. The aeration apparatus according to claim 1, wherein
each of the aeration nozzles further includes the diffuser membrane covering a support body into which the air is introduced and
a large number of the slits formed therein, the fine air bubbles being ejected from the large number of slits.

6. A seawater flue gas desulphurization apparatus, comprising:
a desulfurizer that uses seawater as an absorbent;
a water passage for allowing used seawater discharged from the desulfurizer to flow therethrough and be discharged; and
the aeration apparatus according to claim 1 that is disposed in the water passage, the aeration apparatus generating fine air bubbles in the used seawater to decarbonate the used seawater.

7. A method for removing and preventing a precipitate in a slit in an aeration apparatus, the method comprising:
using an aeration apparatus that is immersed in water to be treated and used to generate fine air bubbles in the water to be treated from a slit of a diffuser membrane of an aeration nozzle;
stopping introduction of air and introducing water into an air supply pipe when pressure loss of the aeration nozzle increases; and
supplying the introduced water to the slit of the diffuser membrane for dissolving and removing a precipitate.

8. The method according to claim 7, further comprising:
stopping introduction of the water; and
introducing air in the air supply pipe to push out the water filled in the air supply pipe, thereby dissolving and removing the precipitate.

9. The method according to claim 7, further comprising:
adding moisture or water vapor to the air to be supplied by discharge unit; and
supplying air containing moisture to the slit of the diffuser membrane.
